(19) United States
(12) Patent Application Publication
(10) Pub. No.: US 2023/0034392 A1
(43) Pub. Date: Feb. 2, 2023

(54) SYSTEM AND METHOD FOR FACILITATING DATA SHARING

(71) Applicant: Flipkart Internet Private Limited, Bengaluru (IN)

(72) Inventors: Pradyot H ADAVI, Bangalore (IN); Pradeep SRINIVASAN, Bangalore (IN); Sujeet KUMAR, Bangalore (IN)

(73) Assignee: Flipkart Internet Private Limited, Bengaluru (IN)

(21) Appl. No.: 17/863,012

(22) Filed: Jul. 12, 2022

(30) Foreign Application Priority Data
Jul. 14, 2021 (IN) 202141031528

(51) Int. Cl. G06Q 30/02

(52) U.S. Cl. CPC G06Q 30/0204

(57) ABSTRACT

A system and method for facilitating data sharing between a first organization and a second organization. The method encompasses initiating, a secure network link between a digital platform of the first organization and the second organization. The method further comprises identifying, a first set of customer identifiers. Thereafter the method comprises receiving, a second bloom filter at the digital platform of the first organization. The method further comprises identifying, a first set of uncommon customers between the first organization and the second organization based on the second bloom filter and the first set of customer identifiers. Thereafter the method encompasses creating, a third bloom filter for the first set of uncommon customers. The method further comprises identifying, at the digital platform of the first organization, a first set of potentially common customers based at least on the third bloom filter and the first set of customer identifiers.

### TECHNICAL FIELD

The present invention generally relates to secure data sharing and more particularly to systems and methods for facilitating data sharing between a first organization and a second organization based on identifying common customer(s) between the first organization and the second organization without disclosing exact customer identifier(s)/details.

### BACKGROUND OF THE DISCLOSURE

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

The advancement in digital technologies has provided organizations multiple platforms to provide better user experience to their customers. Also, better customer insights can help the organizations to build more personalized experiences and products. In order to gather the customer insights efficiently, a diverse dataset about the customers is required. To achieve the diverse dataset about the customers, the organizations generally exchange data of the customers which are common between them. Also, the organizations undertaking the data exchange exercise firstly get the necessary paperwork done in the form of NDA (Non-Disclosure Agreement) and Information Security assessment and such practices are widely in use today based on the sensitivity of data.

Therefore, to provide better user experience to the customers, various organizations partner among themselves and exchange information about the customers which are common to them.

Such data exchange has been predominantly done on the basis of phone number of the customers being a common identifier. Furthermore, for identification of the customers that are common between two organizations, each organization of the two organizations must bring its customer base and find the overlap. Generally, a designated employee carries customer data from one organization to another where the overlap activity is performed on an isolated machine under the watchful eye of the designated employee. Except for the overlap dataset the remaining data is destroyed. The risk in this assessment is exposure of those customers that are not common between the organizations. Also, there is always a risk of exposing personally identifiable information (PII) information about customers during the course of such activity.

In order to deal with the problems associated with the exchange of information between the organizations various solutions are developed time to time. Some of these solutions provides mechanism of using a trusted third party to solve the problem. A trusted third party is generally used that would not reveal the non-common customers and the PII information about the customers of the organizations exchanging information. Also, in some of the known solutions to solve such problems the customer identifier(s) are hashed using a one way hash mechanism such as MD5. The hashed dataset is then transferred either to a trusted third party cloud provider network or to one of the participating organizations. Based on the hashed identifier the overlap is determined and the remaining data is destroyed.

Some of the drawbacks of the aforementioned approaches is that there is a large volume of data that needs to be transported and there is often a need for a trusted third party. Furthermore, these approaches are not suitable for organizations where the customers are being added on a continuous basis and also in the case of a very large dataset, there is always a possibility of hash collision.

Therefore, there is a need in the art to provide a solution to which is faster, secure, and does not need a trusted third party for identification of common customers between the organizations. Hence there is a requirement to provide a system and method for facilitating sharing of data related to the common customer(s) between a first organization and a second organization without disclosing actual PII and/or customer identifier(s) of the customers.

### SUMMARY OF THE DISCLOSURE

This section is provided to introduce certain objects and aspects of the present invention in a simplified form that are further described below in the detailed description. This summary is not intended to identify the key features or the scope of the claimed subject matter.

In order to overcome at least some of the drawbacks mentioned in the previous section and those otherwise known to persons skilled in the art, an object of the present invention is to provide a method and system for facilitating secure data sharing between a first organization and a second organization. Also, an object of the present invention is to identify common customers between organizations without exposing exact customer identifier(s) of customers of the organizations.

Further an object of the present invention is to provide a solution for secure sharing of data of common customer(s) between organizations without exposing the actual personally identifiable information (PII) of the customers of the organizations. Another object of the present invention is to enable organizations to identify their common customers without having to share PII information of their customer. Also, an object of the present invention is to enable organizations to identify their common customers without knowing PII information and/or any customer identifier(s) of the customers from the other organization. An object of the present invention is to provide a secure data sharing platform to share data related to common customers between the organizations as compared to other known solutions. Another object of the present invention is to provide a solution where no third party is required to securely share data related to common customers between the organizations. Also, an object of the present invention is to provide a significant reduction in size of data that is transferred between organizations as compared to previous mechanisms. Yet another object of the present invention is to provide an information in bloom filter (bloom filter is a bit vector with series of 1s and 0s) to identify common customers between organizations, so that there is no information that can be used to derive back a data that was used for construction of the bloom filter.

Furthermore, in order to achieve the aforementioned objectives, the present invention provides a method and system for facilitating data sharing between a first organization and a second organization.

A first aspect of the present invention relates to the method for facilitating data sharing between a first organization and a second organization. The method encompasses initiating, by a transceiver unit, a secure network link between a digital platform of each of the first organization and the second organization. The method further leads to identifying, by an identification unit, a first set of customer identifiers in a first exchange dataset. Thereafter the method comprises receiving, by the transceiver unit, a second bloom filter at the digital platform of the first organization, wherein the second bloom filter is created for a second set of customer identifiers, wherein the second set of customer identifiers is identified in a second exchange dataset. The method further comprises identifying, by the identification unit, at the digital platform of the first organization, a first set of uncommon customers between the first organization and the second organization based on the second bloom filter and the first set of customer identifiers. Thereafter the method encompasses creating, by a processing unit at the digital platform of the first organization, a third bloom filter for the first set of uncommon customers between the first organization and the second organization. The method further comprises identifying, by the identification unit, at the digital platform of the first organization, a first set of potentially common customers based at least on the third bloom filter and the first set of customer identifiers.

Another aspect of the present invention relates to a system for facilitating data sharing between a first organization and a second organization. The system comprises a transceiver unit, configured to initiate, a secure network link between a digital platform of each of the first organization and the second organization. The system further comprises an identification unit, configured to identify, a first set of customer identifiers in a first exchange dataset. Further, the transceiver unit is configured to receive a second bloom filter at the digital platform of the first organization, wherein the second bloom filter is created for a second set of customer identifiers, wherein the second set of customer identifiers is identified in a second exchange dataset. Also, the identification unit is further configured to identify, at the digital platform of the first organization, a first set of uncommon customers between the first organization and the second organization based on the second bloom filter and the first set of customer identifiers. The system further comprises a processing unit, configured to create at the digital platform of the first organization, a third bloom filter for the first set of uncommon customers between the first organization and the second organization. Also, the identification unit is further configured to identify, at the digital platform of the first organization, a first set of potentially common customers based at least on the third bloom filter and the first set of customer identifiers.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes disclosure of electrical components, electronic components or circuitry commonly used to implement such components.

FIG. 1 illustrates an exemplary block diagram of a system [100] for facilitating data sharing between a first organization and a second organization, in accordance with exemplary embodiments of the present invention.

FIG. 2 illustrates an exemplary method flow diagram [200], for facilitating data sharing between a first organization and a second organization, in accordance with exemplary embodiments of the present invention.

The foregoing shall be more apparent from the following more detailed description of the disclosure.

### DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address any of the problems discussed above or might address only some of the problems discussed above.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, processes, and other components may be shown as components in block diagram form in order not to obscure the embodiments in unnecessary detail.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

As used herein, a “processing unit” or “processor” or “operating processor” includes one or more processors, wherein processor refers to any logic circuitry for processing instructions. A processor may be a general-purpose processor, a special purpose processor, a conventional processor, a digital signal processor, a plurality of microprocessors, one or more microprocessors in association with a DSP core, a controller, a microcontroller, Application Specific Integrated Circuits, Field Programmable Gate Array circuits, any other type of integrated circuits, etc. The processor may perform signal coding data processing, input/output processing, and/or any other functionality that enables the working of the system according to the present disclosure. More specifically, the processor or processing unit is a hardware processor.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may be any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. Also, the user device may contain at least one input means configured to receive an input from a processing unit, an identification unit, a storage unit, a transceiver unit and any other such unit(s) which are required to implement the features of the present disclosure.

As used herein, “storage unit” or “memory unit” refers to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As disclosed in the background section the existing technologies have many limitations and in order to overcome at least some of the limitations of the prior known solutions, the present disclosure provides a solution for facilitating data sharing between a first organization and a second organization. More particularly the present invention provides a solution to exchange data related to common customers between organizations without disclosing PII information or customer identifiers of customer(s) of the organizations. Furthermore, to provide the secure data sharing between organizations, the present invention firstly encompasses creating a bloom filter for customer identifier(s) of customers of each organization of the participating organizations. Thereafter said bloom filter corresponding to the customer identifier(s) of the customers of the each participating organization is transferred from the one participating organization to another. Further, the each participating organization from its database identifies its one or more customers that are not present with another participating organization using the bloom filters received from said another participating organization. Further, the each participating organization creates a bloom filter for customer identifier(s) of the one or more customers that are not present with another participating organization. Thereafter, said each participating organization identifies customer(s) that are potentially common between all the participating organizations using at least the bloom filters corresponding to the one or more customers that are not present with another participating organization. Also, each of the participating organization has a public-private key pair and using the public key of itself and that of another participating organization, each participating organization encrypts customer identifiers of customers that are identified as potentially common between the participating organizations. Further, the each participating organization transmits, the customer identifiers of the identified customers that are potentially common between the participating organizations and are encrypted with its public key, to the another participating organization. Thereafter, each participating organization using the received encrypted customer identifiers, calculates an intersect with the customer identifiers that it had encrypted using the public key of said another participating organization, wherein said intersect provides customer identifiers of customers that are common between the participating organizations. Once the customer identifiers of the customers that are common between the participating organizations are identified, a data corresponding to such common customers of the participating organizations is exchanged between the participating organizations.

Therefore, based on the implementation of the features of the present invention the only information that is going outside an organization for identification of common customers between the organizations is bloom filter. In an event of an adversary getting hold of the bloom filter, there is no information that can be used to derive back a data that was used for the construction of the bloom filter. The bloom filter is a bit vector with series of 1s and Os. Also, the size of the bloom filter is significantly smaller compared to original data, thereby saving both time and network bandwidth during data transfer between the organizations. Also, the present invention eliminates the need of any third party environment which is to be trusted and verified by the participating organizations to identify the common customers between said organizations. The present invention provides a solution based on which the common customers can be derived by the organizations within their own environment(s) and neither of the participating organizations are required to share exact customer identifier(s) for the purpose of identification of the common customers.

Hereinafter, exemplary embodiments of the present disclosure will be described in detail with reference to the accompanying drawings so that those skilled in the art can easily carry out the present disclosure.

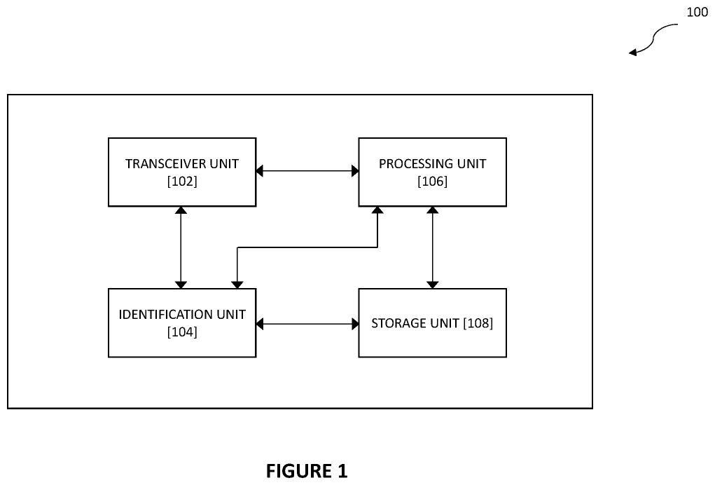

Referring to FIG. 1, an exemplary block diagram of a system [100] for facilitating data sharing between a first organization and a second organization is shown. The system [100] comprises at least one transceiver unit [102], at least one identification unit [104], at least one processing unit [106]and at least one storage unit [108]. Also, all of the components/units of the system [100] are assumed to be connected to each other unless otherwise indicated below. Also, in FIG. 1 only a few units are shown, however, the system [100] may comprise multiple such units or the system [100]may comprise any such numbers of said units, as required to implement the features of the present disclosure. Further, in an implementation, the system [100] may be present in a server device to implement the features of the present invention.

The system [100] is configured to facilitate data sharing between the first organization and the second organization, with the help of the interconnection between the components/units of the system [100].

The transceiver unit [102] is configured to initiate, a secure network link between a digital platform of each of the first organization and the second organization. For instance if a digital platform of the first organization is D1 and a digital platform of the second organization is D2, the transceiver unit [102] is configured to initiate a secure network link between the D1 and D2, wherein the secure link can be initiated via one or more communication means such as including but not limited to via a Bluetooth connection, a Wi-Fi connection, an infrared connection and/or the like.

The transceiver unit [102] is connected to the identification unit [104] and after initiating the secure network link between the digital platform of each of the first organization and the second organization, the identification unit [104] is configured to identify, a first exchange dataset at the digital platform of the first organization. The first exchange dataset is a dataset comprising an information associated with one or more customers of the first organization. Also, identification unit [104] is further configured to identify, a first set of customer identifiers in the first exchange dataset. The first set of customer identifiers comprises one or more customer identifiers of the one or more customers of the first organization. For example, if a dataset A comprising of various details of 1000 customers of first organization is identified at the digital platform of the first organization, the identification unit [104] in such instance is further configured to identify a first set of customer identifiers in the dataset A, wherein said first set of customer identifiers comprises one or more customer identifiers of each customer of the 1000 customers of the first organization. In an implementation, a customer identifier of a customer may be a phone number of said customer or in another implementation a customer identifier of a customer may be an email ID of said customer. Furthermore, in an implementation a customer identifier may be any identifier to identify a customer.

The identification unit [104] is connected to the processing unit [106] and the processing unit [106]is configured to store, the first exchange dataset at a first storage unit, wherein the first storage unit is associated with the digital platform of the first organization. Considering the above example where the dataset A comprising of various details of the 1000 customers of the first organization is identified at the digital platform of the first organization, the processing unit [106] in such scenario is configured to store the dataset A at a storage unit associated with the digital platform of the first organization.

Also, the processing unit [106] is configured to create a first bloom filter for the first set of customer identifiers at the digital platform of the first organization. For instance, in the above example where the dataset A is stored at the storage unit associated with the digital platform of the first organization, the processing unit [106] is configured to create, at the digital platform of the first organization, a bloom filter for the first set of customer identifiers comprising the one or more customer identifiers of each customer of the 1000 customers of the first organization. The processing unit [106] in the given example, is therefore configured to create, at the digital platform of the first organization, the bloom filter for the one or more customer identifiers of each customer of the 1000 customers of the first organization.

Further, the transceiver unit [102] is configured to transmit, the first bloom filter from the digital platform of the first organization to the digital platform of the second organization. Also, the transceiver unit [102] is configured to receive a second bloom filter at the digital platform of the first organization from the digital platform of the second organization, wherein the second bloom filter is created for a second set of customer identifiers at the digital platform of the second organization. Also, at the digital platform of the second organization, the second set of customer identifiers is identified in a second exchange dataset. The second exchange dataset is also identified at the digital platform of the second organization and the second exchange dataset is a dataset comprising an information associated with one or more customers of the second organization. The second set of customer identifiers comprises one or more customer identifiers of the one or more customers of the second organization. Also, the second exchange dataset is stored at a second storage unit, wherein the second storage unit is associated with the digital platform of the second organization.

Thereafter, the identification unit [104] is configured to identify, at the digital platform of the first organization, a first set of uncommon customers between the first organization and the second organization based on the second bloom filter and the first set of customer identifiers. Also, at the digital platform of the second organization a second set of uncommon customers between the first organization and the second organization is identified based on the first bloom filter and the second set of customer identifiers. For example, if a first set of customer identifiers comprises customer identifiers d, e, f, h and i and a second bloom filter corresponding to a second set of customer identifiers is received at the digital platform of the first organization, wherein second set of customer identifiers comprising customer identifiers h, i, j, k and I. The identification unit

in such instance may be configured to identify at the digital platform of the first organization, customers corresponding to d, e and f as the first set of uncommon customers between the first organization and the second organization based on the second bloom filter and the first set of customer identifiers. Also, in the given example a first bloom filter corresponding to the first set of customer identifiers is transmitted from the digital platform of the first organization to the digital platform of the second organization. Further, at the digital platform of the second organization, customers corresponding to j and k may be identified as a second set of uncommon customers between the first organization and the second organization based on the first bloom filter and the second set of customer identifiers.

Thereafter, the processing unit [106] is configured to create at the digital platform of the first organization, a third bloom filter for the first set of uncommon customers between the first organization and the second organization. Also, at the digital platform of the second organization a fourth bloom filter is created for the second set of uncommon customers between the first organization and the second organization. Considering the above example, where the customers corresponding to d, e and f are identified as the first set of uncommon customers between the first organization and the second organization and the customers corresponding to j and k are identified as the second set of uncommon customers between the first organization and the second organization, the processing unit [106] in the given instance is configured to create at the digital platform of the first organization, a third bloom filter for the customers corresponding to d, e and f associated with the first set of uncommon customers between the first organization and the second organization. Also, in the given example, at the digital platform of the second organization a fourth bloom filter is created for the customers corresponding to j and k associated with the second set of uncommon customers between the first organization and the second organization.

Further, the identification unit [104] is configured to identify, at the digital platform of the first organization, a first set of potentially common customers based at least on the third bloom filter and the first set of customer identifiers. The first set of potentially common customers is identified to facilitate data sharing between the first organization and the second organization. Also, at the digital platform of the second organization, a second set of potentially common customers is identified based at least on the fourth bloom filter and the second set of customer identifiers. The second set of potentially common customers is also identified to facilitate data sharing between the first organization and the second organization. Each of the first set of potentially common customers and the second set of potentially common customers comprises one or more customers that are potentially common to the first organization and the second organization. Considering the above example where the third bloom filter for the customers corresponding to d, e and f associated with the first set of uncommon customers between the first organization and the second organization is created, the identification unit [104] in the given instance is configured to identify, at the digital platform of the first organization, the first set of potentially common customers based at least on the third bloom filter created for the customers corresponding to d, e and f and the first set of customer identifiers comprising customer identifiers d, e, f, h and i. For instance, in the given example h and i may be identified as the first set of potentially common customers. Also, in the given example, at the digital platform of the second organization, the second set of potentially common customers is identified based at least on the fourth bloom filter created for customers corresponding to j and k and the second set of customer identifiers comprising customer identifiers h, i, j, k and I. For instance, in the given example h, i and I may be identified as the second set of potentially common customers.

The digital platform of the first organization comprises a public-private key pair for instance (PubD1, PriD1) and similarly the digital platform of the second organization comprises a public-private key pair for instance (PubD2, PriD2). Further, the processing unit [106] is configured to encrypt at the digital platform of the first organization, the first set of potentially common customers, based on the public encryption key of the first organization and the public encryption key of the second organization. Considering the above example, where the h and i are identified as the first set of potentially common customers, the processing unit [106] is configured to encrypt at the digital platform of the first organization the h and i as below:

PubD1(h)=m1 PubD2(h)=n1

PubD1(i)=m2 PubD2(i)=n2

where PubD1 is the public encryption key of the first organization and the PubD2 is the public encryption key of the second organization.

Also, the second set of potentially common customers, at the digital platform of the second organization is encrypted based on a public encryption key of the first organization and a public encryption key of the second organization. Considering the above example, where the h, i and I are identified as the second set of potentially common customers, in the given example, at the digital platform of the second organization the h i and I are encrypted as below:

PubD2(h)=n1 PubD1(h)=m1

PubD2(i)=n2 PubD1(i)=m2

PubD2(I)=n3 PubD1(I)=m3

where PubD1 is the public encryption key of the first organization and the PubD2 is the public encryption key of the second organization.

Further, the transceiver unit [102] is configured to receive at the digital platform of the first organization from the digital platform of the second organization, the second set of potentially common customers encrypted with the public encryption key of the second organization. Further, identification unit [104] is configured to identify at the digital platform of the first organization, a first set of common customers based on the received second set of potentially common customers encrypted with the public encryption key of the second organization, and the first set of potentially common customers encrypted with the public encryption key of the second organization. The first set of common customers comprises one or more customers that are common to the first organization and the second organization. Considering the above example, where the n1, n2 and n3 are the second set of potentially common customers encrypted with the public encryption key of the second organization, in the given example, the transceiver unit [102] is configured to receive the n1, n2 and n3 at the digital platform of the first organization. Thereafter, the identification unit [104] is configured to identify at the digital platform of the first organization, the first set of common customers based on the n1, n2 and n3, and the first set of potentially common customers encrypted with the public encryption key of the second organization i.e. n1 and n2. In the given instance, customers corresponding to the n1 and n2 are identified as the first set of common customers.

Also, the transceiver unit [102] is configured to transmit from the digital platform of the first organization to the digital platform of the second organization, the first set of potentially common customers encrypted with the public encryption key of the first organization, wherein at the digital platform of the second organization a second set of common customers is identified based on the received first set of potentially common customers encrypted with the public encryption key of the first organization and the second set of potentially common customers encrypted with the public encryption key of the first organization. The second set of common customers comprises the one or more customers that are common to the first organization and the second organization. Considering the above example, where at the digital platform of the first organization, the m1 and m2 indicates the first set of potentially common customers encrypted with the public encryption key of the first organization, in the given example, the transceiver unit [102]is configured to transmit the m1 and m2 at the digital platform of the second organization. Thereafter, at the digital platform of the second organization, the second set of common customers is identified based on the received m1 and m2, and the second set of potentially common customers encrypted at the digital platform of the second organization with the public encryption key of the first organization i.e. m1, m2 and m3. In the given instance, customers corresponding to the m1 and m2 are identified as the second set of common customers.

Further, the transceiver unit [102] is configured to transmit, from the digital platform of the first organization to the digital platform of the second organization, a data corresponding to the first set of common customers. Also, the transceiver unit [102] is configured to receive, at the digital platform of the first organization from the digital platform of the second organization, a data corresponding to the second set of common customers. Considering the above example, where the customers corresponding to the n1 and n2 are identified as the first set of common customers at the digital platform of the first organization and the customers corresponding to the m1 and m2 are identified as the second set of common customers at the digital platform of the second organization. The transceiver unit [102] in the given instance is configured to transmit, from the digital platform of the first organization to the digital platform of the second organization, a data corresponding to the n1 and n2. Also, in the given instance, the transceiver unit [102] is configured to receive, at the digital platform of the first organization from the digital platform of the second organization, a data corresponding to the m1 and m2. Therefore, based on the implementation of the features of the present invention, the data of the customers common between the first organization and the second organization is exchanged securely and efficiently.

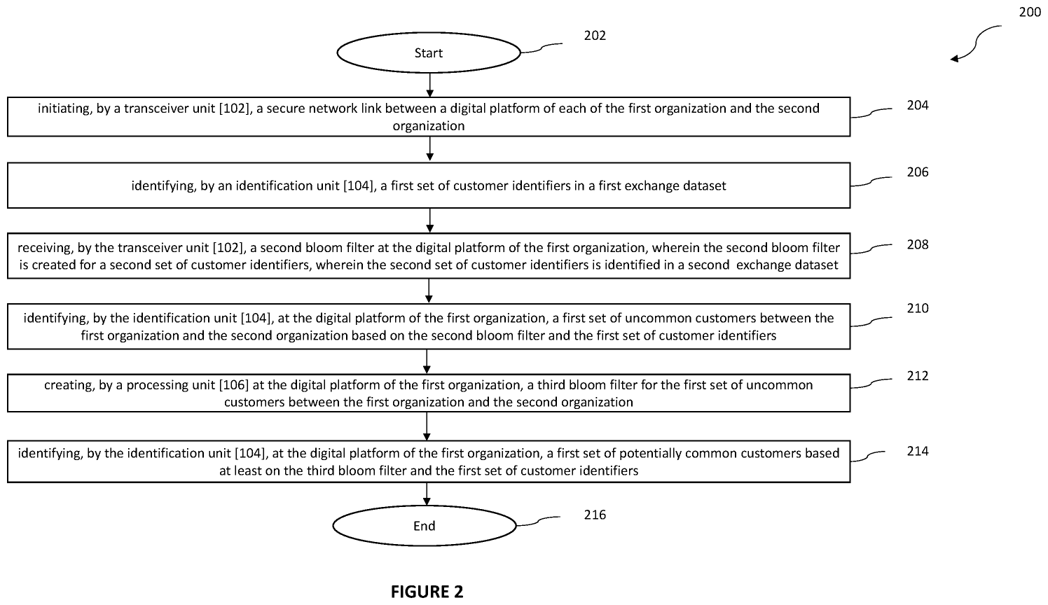

Referring to FIG. 2 an exemplary method flow diagram [200], for facilitating data sharing between a first organization and a second organization, in accordance with exemplary embodiments of the present invention is shown. In an implementation the method is performed by the system [100]. Further, in an implementation, the system [100] may be present in a server device to implement the features of the present invention. Also, as shown in FIG. 2, the method starts at step [202].

At step [204] the method comprises initiating, by a transceiver unit [102], a secure network link between a digital platform of each of the first organization and the second organization. For instance if a digital platform of the first organization is D1 and a digital platform of the second organization is D2, the method comprises initiating by the transceiver unit [102], a secure network link between the D1 and D2, wherein the secure link can be initiated via one or more communication means such as including but not limited to via a Bluetooth connection, a Wi-Fi connection, an infrared connection and/or the like.

After initiating the secure network link between the digital platform of each of the first organization and the second organization, the method comprises identifying, by the identification unit [104], the first exchange dataset at the digital platform of the first organization. The first exchange dataset is a dataset comprising an information associated with one or more customers of the first organization. Next at step [206] the method comprises identifying, by an identification unit [104], a first set of customer identifiers in the first exchange dataset. The first set of customer identifiers comprises one or more customer identifiers of the one or more customers of the first organization. For example, if a dataset ABC comprising of various details of 5000 customers of first organization is identified at the digital platform of the first organization, the method in such instance comprises identifying by the identification unit [104], a first set of customer identifiers in the dataset ABC, wherein said first set of customer identifiers comprises one or more customer identifiers of each customer of the 5000 customers of the first organization. In an implementation, a customer identifier of a customer may be a phone number of said customer or in another implementation a customer identifier of a customer may be an email ID of said customer. Furthermore, in an implementation a customer identifier may be any identifier to identify a customer.

The method further comprises storing, by a processing unit [106], the first exchange dataset at a first storage unit, wherein the first storage unit is associated with the digital platform of the first organization. Considering the above example where the dataset ABC comprising of various details of the 5000 customers of the first organization is identified at the digital platform of the first organization, the method in such scenario encompasses storing by the processing unit [106], the dataset ABC at a storage unit associated with the digital platform of the first organization.

Also, the method comprises creating, by the processing unit [106], a first bloom filter for the first set of customer identifiers, at the digital platform of the first organization. For instance, in the above example where the dataset ABC is stored at the storage unit associated with the digital platform of the first organization, the method encompasses creating by the processing unit [106], at the digital platform of the first organization, a bloom filter for the first set of customer identifiers comprising the one or more customer identifiers of the each customer of the 5000 customers of the first organization. The method in the given example, is therefore encompasses creating by the processing unit [106] at the digital platform of the first organization, the bloom filter for the one or more customer identifiers of the each customer of the 5000 customers of the first organization. The method thereafter leads to transmitting, by the transceiver unit, [102], the first bloom filter from the digital platform of the first organization to the digital platform of the second organization.

Also, at step [208] the method comprises receiving, by the transceiver unit [102], a second bloom filter at the digital platform of the first organization from the digital platform of the second organization, wherein the second bloom filter is created for a second set of customer identifiers at the digital platform of the second organization. Also, at the digital platform of the second organization, the second set of customer identifiers is identified in a second exchange dataset. The second exchange dataset is also identified at the digital platform of the second organization and the second exchange dataset is a dataset comprising an information associated with one or more customers of the second organization. The second set of customer identifiers comprises one or more customer identifiers of the one or more customers of the second organization. Also, the second exchange dataset is stored at a second storage unit, wherein the second storage unit is associated with the digital platform of the second organization

Next, at step [210] the method comprises identifying, by the identification unit [104], at the digital platform of the first organization, a first set of uncommon customers between the first organization and the second organization based on the second bloom filter and the first set of customer identifiers. Also, at the digital platform of the second organization a second set of uncommon customers between the first organization and the second organization is identified based on the first bloom filter and the second set of customer identifiers. For example, if a first set of customer identifiers comprises customer identifiers j, k, I, m and n and a second bloom filter corresponding to a second set of customer identifiers is received at the digital platform of the first organization, wherein second set of customer identifiers comprising customer identifiers m, n, o, p and q. The method via the identification unit [104], in such instance encompasses identifying at the digital platform of the first organization, customers corresponding to j, k and I as the first set of uncommon customers between the first organization and the second organization based on the second bloom filter and the first set of customer identifiers. Also, in the given example a first bloom filter corresponding to the first set of customer identifiers is transmitted from the digital platform of the first organization to the digital platform of the second organization. Further, at the digital platform of the second organization, customers corresponding to o and p may be identified as a second set of uncommon customers between the first organization and the second organization based on the first bloom filter and the second set of customer identifiers.

Thereafter, at step [212] the method comprises creating, by a processing unit [106] at the digital platform of the first organization, a third bloom filter for the first set of uncommon customers between the first organization and the second organization. Also, at the digital platform of the second organization a fourth bloom filter is created for the second set of uncommon customers between the first organization and the second organization. Considering the above example, where the customers corresponding to j, k and I are identified as the first set of uncommon customers between the first organization and the second organization and the customers corresponding to o and p are identified as the second set of uncommon customers between the first organization and the second organization, the method in the given instance encompasses creating by the processing unit [106] at the digital platform of the first organization, a third bloom filter for the customers corresponding to j, k and I associated with the first set of uncommon customers between the first organization and the second organization. Also, in the given example, at the digital platform of the second organization a fourth bloom filter is created for the customers corresponding to o and p associated with the second set of uncommon customers between the first organization and the second organization.

Next, at step [214] the method comprises identifying, by the identification unit [104], at the digital platform of the first organization, a first set of potentially common customers based at least on the third bloom filter and the first set of customer identifiers. The first set of potentially common customers is identified to facilitate data sharing between the first organization and the second organization. Also, at the digital platform of the second organization, a second set of potentially common customers is identified based at least on the fourth bloom filter and the second set of customer identifiers. The second set of potentially common customers is also identified to facilitate data sharing between the first organization and the second organization. Each of the first set of potentially common customers and the second set of potentially common customers comprises one or more customers that are potentially common to the first organization and the second organization. Considering the above example where the third bloom filter for the customers corresponding to j, k and I associated with the first set of uncommon customers between the first organization and the second organization is created, the method in the given instance encompasses identifying by the identification unit [104], at the digital platform of the first organization, the first set of potentially common customers based at least on the third bloom filter created for the customers corresponding to j, k and I and the first set of customer identifiers comprising customer identifiers j, k, I, m and n. For instance, in the given example m and n may be identified as the first set of potentially common customers. Also, in the given example, at the digital platform of the second organization, the second set of potentially common customers is identified based at least on the fourth bloom filter created for customers corresponding to o and p and the second set of customer identifiers comprising customer identifiers m, n, o, p and q. For instance, in the given example m, n and q may be identified as the second set of potentially common customers.

The digital platform of the first organization comprises a public-private key pair for instance (PubD1, PriD1) and similarly the digital platform of the second organization comprises a public-private key pair for instance (PubD2, PriD2). Thereafter, the method comprises encrypting by the processing unit [106] at the digital platform of the first organization, the first set of potentially common customers, based on the public encryption key of the first organization and the public encryption key of the second organization. Considering the above example, where the m and n are identified as the first set of potentially common customers, the method encompasses encrypting by the processing unit [106] at the digital platform of the first organization the m and n as below:

PubD1(m)=a1 PubD2(m)=b1

PubD1(n)=a2 PubD2(n)=b2

where PubD1 is the public encryption key of the first organization and the PubD2 is the public encryption key of the second organization.

Also, the second set of potentially common customers, at the digital platform of the second organization is further encrypted based on a public encryption key of the first organization and a public encryption key of the second organization. Considering the above example, where the m, n and q are identified as the second set of potentially common customers, in the given example, at the digital platform of the second organization the m, n and q are encrypted as below:

PubD2(m)=b1 PubD1(m)=a1

PubD2(n)=b2 PubD1(n)=a2

PubD2(q)=b3 PubD1(q)=a3

where the PubD1 is the public encryption key of the first organization and the PubD2 is the public encryption key of the second organization.

The method further leads to receiving, by the transceiver unit [102] at the digital platform of the first organization from the digital platform of the second organization, the second set of potentially common customers encrypted with the public encryption key of the second organization. Further the method comprises identifying, by the identification unit [104] at the digital platform of the first organization, a first set of common customers based on the received second set of potentially common customers encrypted with the public encryption key of the second organization, and the first set of potentially common customers encrypted with the public encryption key of the second organization. The first set of common customers comprises one or more customers that are common to the first organization and the second organization. Considering the above example, where the b1, b2 and b3 are the second set of potentially common customers encrypted with the public encryption key of the second organization, in the given example, the method encompasses receiving by the transceiver unit [102] the b1, b2 and b3 at the digital platform of the first organization. Thereafter, the method encompasses identifying by the identification unit [104] at the digital platform of the first organization, the first set of common customers based on the b1, b2 and b3, and the first set of potentially common customers encrypted with the public encryption key of the second organization i.e. b1 and b2. In the given instance, customers corresponding to the b1 and b2 are identified as the first set of common customers.

Also, the method comprises transmitting, by the transceiver unit [102] from the digital platform of the first organization to the digital platform of the second organization, the first set of potentially common customers encrypted with the public encryption key of the first organization. Further, at the digital platform of the second organization a second set of common customers is identified based on the received first set of potentially common customers encrypted with the public encryption key of the first organization and the second set of potentially common customers encrypted with the public encryption key of the first organization. The second set of common customers comprises the one or more customers that are common to the first organization and the second organization. Considering the above example, where at the digital platform of the first organization, the a1 and a2 indicates the first set of potentially common customers encrypted with the public encryption key of the first organization, in the given example, the method encompasses transmitting by the transceiver unit [102] the a1 and a2 at the digital platform of the second organization. Thereafter, at the digital platform of the second organization, the second set of common customers is identified based on the received a1 and a2, and the second set of potentially common customers encrypted at the digital platform of the second organization with the public encryption key of the first organization i.e. a1, a2 and a3. In the given instance, customers corresponding to the a1 and a2 are identified as the second set of common customers.

Thereafter, the method comprises transmitting, by the transceiver unit [102] from the digital platform of the first organization to the digital platform of the second organization, a data corresponding to the first set of common customers. Also the method comprises receiving, by the transceiver unit [102] at the digital platform of the first organization from the digital platform of the second organization, a data corresponding to the second set of common customers. Considering the above example, where the customers corresponding to the b1 and b2 are identified as the first set of common customers at the digital platform of the first organization and the customers corresponding to the a1 and a2 are identified as the second set of common customers at the digital platform of the second organization. The method in the given instance encompasses transmitting by the transceiver unit [102], from the digital platform of the first organization to the digital platform of the second organization, a data corresponding to the b1 and b2. Also, in the given instance, the method encompasses receiving by the transceiver unit

, at the digital platform of the first organization from the digital platform of the second organization, a data corresponding to the a1 and a2. Therefore, based on the implementation of the features of the present invention, the data of the customers that are common between the first organization and the second organization is exchanged securely and efficiently.

Thereafter, the method terminates at step [216].

Furthermore, a use case of the present invention is provided below:

In order to exchange information of common customers between two organizations, A and B. Let us consider a first exchange dataset (i.e. dataset associated with organizations A i.e. OrgA) as Ea and a second exchange dataset (i.e. dataset associated with organizations B i.e. OrgB) Eb. Also, there are two digital platforms namely Aa and Ab deployed at the OrgA and the OrgB respectively.

Further the exemplary dataset Ea and Eb are provided as below in Table 1 and Table 2, respectively:

TABLE 1

| Customer | | | | | | Is |
|---|---|---|---|---|---|---|
| ID | F1 | F2 | F3 | F4 | F5 | Common |
| a | 1 | P | 0.1 | Y | 10 | |
| b | 0 | D | 0.4 | Y | 5 | |
| c | 1 | D | 0.8 | Y | 60 | |
| d | 1 | P | 0.9 | N | 30 | |
| e | 0 | P | 0.2 | Y | 8 | |
| z | 1 | D | 0.7 | N | 21 | |

TABLE 2

| Customer ID | F1 | F2 | F3 | Is Common |
|---|---|---|---|---|
| a | 28 | NA | 70,000 | |
| e | 60 | Pass | 10,000 | |
| f | 42 | Pass | 90,000 | |
| g | 70 | Fail | 5,000 | |
| x | 52 | Pass | 60,000 | |
| y | 48 | Fail | 8,000 | |

In the above Table 1 each cell of first column contains customer identifier for customer of the OrgA, each cell of second to sixth (i.e. F1 to F5) columns indicates various features/details of the customer corresponding to the customer identifier present in the adjacent cell in the first column and each cell of seventh column (i.e. Is column) indicates if a customer corresponding to the customer identifier present in the corresponding cell in the first column is common between the organization A (OrgA) and the organization B (OrgB).

In Table 2 each cell of first column contains customer identifier for customer of the OrgB, each cell of second to fourth (i.e. F1 to F3) columns indicates various features/details of customer corresponding to the customer identifier present in the adjacent cell in the first column and each cell of fifth column (i.e. Is column) indicates if a customer corresponding to the customer identifier present in the corresponding cell in the first column is common between the organization A (OrgA) and organization B (OrgB).

Therefore, the customer identifiers of the organization A (OrgA) are a, b, c, d, e, z and the customer identifiers of the organization B (OrgB) are a, e, f, g, x, y.

In order to exchange the information of common customers between the two organizations, A and B at Step 01 Aa and Ab establish a secure network link between the OrgA and the OrgB and come to a consensus for performing overlap through a consensus technique.

Thereafter at Step 02, Ea is uploaded to the digital platform Aa and Eb is uploaded to the digital platform Ab. In an implementation both of these uploads can be done independently. As part of the upload the first columns of each of the Ea and Eb are indicated to be used as columns for performing overlap.

Further at Step 03 the digital platform Aa creates a bloom filter BFa for cell values (i.e. the customer identifiers) present in the first column of the Ea and similarly the digital platform Ab creates a bloom filter BFb using cell values (the customer identifiers) present in the first column of the Eb. Once done, both the digital platforms Aa and Ab indicate the same to each other and are ready for performing the next set of steps.

Next at Step 04 the digital platform Aa transfers the BFa to the digital platform Ab and the digital platform Ab transfers the BFb to the digital platform Aa. Since bloom filter contains only a series of 0s and 1s (bit vectors), neither of the organizations A and B will know the exact customer identifiers from the received bloom filter.

Further at Step 05 using the BFb, the digital platform Aa finds one or more customers from the first column of Ea that are not present with the OrgB. In an implementation, the digital platform Aa finds b, c and d as the customers that are not present with the OrgB. Similarly, the digital platform Ab finds one or more customers from the first column of Eb that are not present with the OrgA. In an implementation, the digital platform Ab finds f and g as the customers that are not present with the OrgA.

Further at Step 06, using b, c and d (i.e. the customers that are identified as not present with the OrgB in the above step), the digital platform Aa creates a bloom filter BFb′ (BFb dash) and using BFb′ the digital platform Aa determines one or more customers that are potentially common to the OrgA and the OrgB. In an implementation, the one or more customers that are potentially common to the OrgA and the OrgB are determined as a, e, and z at the digital platform Aa by analyzing the customer identifiers present in the first column of the Ea and the customers that are identified as not present with the OrgB (b, c and d) using the bloom filter BFb′.

Also, at Step 06 using f and g (the customers that are identified as not present with the OrgA in the above step), the digital platform Ab creates a bloom filter BFa′ (BFa dash) and using BFa′ the digital platform Ab determines one or more customers that are potentially common to the OrgA and the OrgB. In an implementation, the one or more customers that are potentially common to the OrgA and the OrgB are determined as a, e, x and y at the digital platform Ab by analyzing the customer identifiers present in the first column of the Eb and the customers that are identified as not present with the OrgA (f and g) using the bloom filter BFa′.

Further, in an implementation each customer other than the identified potential common customers in the 7th column (i.e. Is Common column) of the Ea and in the 5th column (i.e. Is Common column) of Eb is marked as No.

Further the OrgA has a public-private key pair i.e. (PubA, PriA) and similarly the OrgB has a public-private key pair (PubB, PriB). Next at Step 07 using the public key of itself and that of the OrgB, the OrgA encrypts the potential common customers derived in the Step 6. i.e., {a, e, z}

PubA(a)=m1 PubB(a)=n1

PubA(e)=m2 PubB(e)=n2

PubA(z)=m3 PubB(z)=n3

Similarly, the OrgB encrypts the potential common customers derived in the Step 6. i.e. {a, e, x, y} using the OrgA public key and its own public key.

PubB(a)=n1 PubA(a)=m1

PubB(e)=n2 PubA(e)=m2

PubB(x)=n4 PubA(x)=m4

PubB(y)=n5 PubA(y)=m5

Thereafter the OrgA sends the m1, m2 and m3 to the OrgB and the OrgB sends the n1, n2, n4 and n5 to the OrgA.

Further at Step 08, the OrgA using dataset (i.e. n1, n2, n4 and n5) sent by the OrgB from the previous step, calculates intersect with dataset (i.e. n1, n2 and n3) that it had prepared using the public key. i.e. the PubB of the OrgB. Further based on the intersection n1 and n2 are identified as the common customers between the OrgA and the OrgB, at the OrgA. Since the OrgA does not possess the PriB, it will not be able derive the actual identifier corresponding to n4 and n5.

Thereafter, customers corresponding to n1 and n2, i.e. a and e respectively are marked as Yes under the 7^{th} column i.e. “Is Common” in Ea, as indicated in Table 3 below.

TABLE 3

| Customer | | | | | | Is |
|---|---|---|---|---|---|---|
| ID | F1 | F2 | F3 | F4 | F5 | Common |
| a | 1 | P | 0.1 | Y | 10 | Yes |
| b | 0 | D | 0.4 | Y | 5 | No |
| c | 1 | D | 0.8 | Y | 60 | No |
| d | 1 | P | 0.9 | N | 30 | No |
| e | 0 | P | 0.2 | Y | 8 | Yes |
| z | 1 | D | 0.7 | N | 21 | No |

Similarly, using the public key of the OrgA, the OrgB encrypts {a, e, x, y} which would result in m1, m2, m4 and m5. Also based on the m1, m2, m4 and m5 and the m1, m2 and m3 received from OrgA, the OrgB identifies m1 and m2 as the common customers between the OrgA and the OrgB.

Thereafter, the customers corresponding to m1 and m2, i.e. a and e respectively are marked as Yes under the 5^{th} column i.e. “Is Common” of Eb as indicated in Table 4 below. Since the OrgB does not possess the PriA, it will not be able derive the actual identifier corresponding to m3.

TABLE 4

| Customer ID | F1 | F2 | F3 | Is Common |
|---|---|---|---|---|
| a | 28 | NA | 70,000 | Yes |
| e | 60 | Pass | 10,000 | Yes |
| f | 42 | Pass | 90,000 | No |
| g | 70 | Fail | 5,000 | No |
| x | 52 | Pass | 60,000 | No |
| y | 48 | Fail | 8,000 | No |

Once the common customers (i.e. a and e) are identified, the digital platforms Aa and Ab would exchange the data present in the remaining columns of Ea and Eb for the rows which are marked as Yes.

Thus, the present invention provides a novel solution for facilitating sharing of a data of common customers between a first organization and a second organization. Also, based on the implementation of the features of the present invention the only information that is going outside an organization for identification of common customers between organizations is bloom filter. In an event of an adversary getting hold of the bloom filter, there is no information that can be used to derive back a data that was used for the construction of the bloom filter. The size of the bloom filter is significantly smaller compared to original data, thereby saving both time and network bandwidth during data transfer between the organizations. Also, the present invention eliminates the need of any third party environment which is to be trusted and verified by the participating organizations to identify the common customers between said organizations. The present invention provides a solution based on which the common customers can be derived by the organizations within their own environment(s) and neither of the participating organizations are required to share exact customer identifier(s) for the purpose of identification of the common customers.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter to be implemented merely as illustrative of the invention and not as limitation.

1. A method for facilitating data sharing between a first organization and a second organization, the method comprising:
initiating, by a transceiver unit [102], a secure network link between a digital platform of each of the first organization and the second organization;
identifying, by an identification unit [104], a first set of customer identifiers in a first exchange dataset;
receiving, by the transceiver unit [102], a second bloom filter at the digital platform of the first organization, wherein the second bloom filter is created for a second set of customer identifiers, wherein the second set of customer identifiers is identified in a second exchange dataset;
identifying, by the identification unit [104], at the digital platform of the first organization, a first set of uncommon customers between the first organization and the second organization based on the second bloom filter and the first set of customer identifiers;
creating, by a processing unit [106] at the digital platform of the first organization, a third bloom filter for the first set of uncommon customers between the first organization and the second organization; and
identifying, by the identification unit [104], at the digital platform of the first organization, a first set of potentially common customers based at least on the third bloom filter and the first set of customer identifiers.

2. The method as claimed in claim 1, wherein the first set of potentially common customers is identified to facilitate data sharing between the first organization and the second organization.

3. The method as claimed in claim 1, wherein the first set of customer identifiers comprises one or more customer identifiers of one or more customers of the first organization and the second set of customer identifiers comprises one or more customer identifiers of one or more customers of the second organization.

4. The method as claimed in claim 1, the method comprises:
identifying, by the identification unit [104], the first exchange dataset at the digital platform of the first organization, and
storing, by the processing unit [106], the first exchange dataset at a first storage unit, wherein the first storage unit is associated with the digital platform of the first organization.

5. The method as claimed in claim 1, wherein the second exchange dataset is identified at the digital platform of the second organization.

6. The method as claimed in claim 1, the method comprises:
creating, by the processing unit [106], a first bloom filter for the first set of customer identifiers, at the digital platform of the first organization,
transmitting, by the transceiver unit [102], the first bloom filter from the digital platform of the first organization to the digital platform of the second organization, wherein, at the digital platform of the second organization:
a second set of uncommon customers between the first organization and the second organization is identified based on the first bloom filter and the second set of customer identifiers,
a fourth bloom filter is created for the second set of uncommon customers between the first organization and the second organization, and
a second set of potentially common customers is identified based at least on the fourth bloom filter and the second set of customer identifiers, wherein the second set of potentially common customers, at the digital platform of the second organization is further encrypted based on a public encryption key of the first organization and a public encryption key of the second organization.

7. The method as claimed in claim 6, wherein each of the first set of potentially common customers and the second set of potentially common customers comprises one or more customers that are potentially common to the first organization and the second organization.

8. The method as claimed in claim 1, the method further comprises:
encrypting by the processing unit [106] at the digital platform of the first organization, the first set of potentially common customers, based on the public encryption key of the first organization and the public encryption key of the second organization,
receiving, by the transceiver unit [102] at the digital platform of the first organization from the digital platform of the second organization, the second set of potentially common customers encrypted with the public encryption key of the second organization, and
identifying, by the identification unit [104] at the digital platform of the first organization, a first set of common customers based on the received second set of potentially common customers encrypted with the public encryption key of the second organization and the first set of potentially common customers encrypted with the public encryption key of the second organization.

9. The method as claimed in claim 8, the method further comprises transmitting, by the transceiver unit [102] from the digital platform of the first organization to the digital platform of the second organization, the first set of potentially common customers encrypted with the public encryption key of the first organization, wherein at the digital platform of the second organization:
a second set of common customers is identified based on the received first set of potentially common customers encrypted with the public encryption key of the first organization and the second set of potentially common customers encrypted with the public encryption key of the first organization.

10. The method as claimed in claim 9, wherein each of the first set of common customers and the second set of common customers comprises one or more customers that are common to the first organization and the second organization.

11. The method as claimed in claim 10, the method further comprises:
transmitting, by the transceiver unit [102] from the digital platform of the first organization to the digital platform of the second organization, a data corresponding to the first set of common customers, and
receiving, by the transceiver unit [102] at the digital platform of the first organization from the digital platform of the second organization, a data corresponding to the second set of common customers.

12. A system for facilitating data sharing between a first organization and a second organization, the system comprising:
a transceiver unit [102], configured to initiate, a secure network link between a digital platform of each of the first organization and the second organization;
an identification unit [104], configured to identify, a first set of customer identifiers in a first exchange dataset, wherein:
the transceiver unit [102] is further configured to receive a second bloom filter at the digital platform of the first organization, wherein the second bloom filter is created for a second set of customer identifiers, wherein the second set of customer identifiers is identified in a second exchange dataset, and
the identification unit [104] is further configured to identify, at the digital platform of the first organization, a first set of uncommon customers between the first organization and the second organization based on the second bloom filter and the first set of customer identifiers; and
a processing unit [106], configured to create at the digital platform of the first organization, a third bloom filter for the first set of uncommon customers between the first organization and the second organization, wherein:
identification unit [104] is further configured to identify, at the digital platform of the first organization, a first set of potentially common customers based at least on the third bloom filter and the first set of customer identifiers.

13. The system as claimed in claim 12, wherein the first set of potentially common customers is identified to facilitate data sharing between the first organization and the second organization.

14. The system as claimed in claim 12, wherein the first set of customer identifiers comprises one or more customer identifiers of one or more customers of the first organization and the second set of customer identifiers comprises one or more customer identifiers of one or more customers of the second organization.

15. The system as claimed in claim 12, wherein the identification unit [104] is further configured to identify, the first exchange dataset at the digital platform of the first organization.

16. The system as claimed in claim 15, wherein the processing unit [106] is further configured to store, the first exchange dataset at a first storage unit, wherein the first storage unit is associated with the digital platform of the first organization.

17. The system as claimed in claim 12, wherein the second exchange dataset is identified at the digital platform of the second organization.

18. The system as claimed in claim 12, wherein the processing unit [106] is configured to create a first bloom filter for the first set of customer identifiers at the digital platform of the first organization.

19. The system as claimed in claim 18, wherein the transceiver unit [102] is further configured to transmit, the first bloom filter from the digital platform of the first organization to the digital platform of the second organization, wherein, at the digital platform of the second organization:
a second set of uncommon customers between the first organization and the second organization is identified based on the first bloom filter and the second set of customer identifiers,
a fourth bloom filter is created for the second set of uncommon customers between the first organization and the second organization, and
a second set of potentially common customers is identified based at least on the fourth bloom filter and the second set of customer identifiers, wherein the second set of potentially common customers, at the digital platform of the second organization is further encrypted based on a public encryption key of the first organization and a public encryption key of the second organization.

20. The system as claimed in claim 19, wherein each of the first set of potentially common customers and the second set of potentially common customers comprises one or more customers that are potentially common to the first organization and the second organization.

21. The system as claimed in claim 12, wherein:
the processing unit [106] is further configured to encrypt at the digital platform of the first organization, the first set of potentially common customers, based on the public encryption key of the first organization and the public encryption key of the second organization,
the transceiver unit [102] is further configured to receive at the digital platform of the first organization from the digital platform of the second organization, the second set of potentially common customers encrypted with the public encryption key of the second organization, and
the identification unit [104] is further configured to identify at the digital platform of the first organization, a first set of common customers based on the received second set of potentially common customers encrypted with the public encryption key of the second organization and the first set of potentially common customers encrypted with the public encryption key of the second organization.

22. The system as claimed in claim 21, wherein the transceiver unit [102] is further configured to transmit from the digital platform of the first organization to the digital platform of the second organization, the first set of potentially common customers encrypted with the public encryption key of the first organization, wherein at the digital platform of the second organization:
a second set of common customers is identified based on the received first set of potentially common customers encrypted with the public encryption key of the first organization and the second set of potentially common customers encrypted with the public encryption key of the first organization.

23. The system as claimed in claim 22, wherein each of the first set of common customers and the second set of common customers comprises one or more customers that are common to the first organization and the second organization.

24. The system as claimed in claim 23, wherein the transceiver unit [102] is further configured to:
transmit, from the digital platform of the first organization to the digital platform of the second organization, a data corresponding to the first set of common customers, and
receive, at the digital platform of the first organization from the digital platform of the second organization, a data corresponding to the second set of common customers.
